(19) United States
(12) Patent Application Publication
(10) Pub. No.: US 2003/0184501 A1
(43) Pub. Date: Oct. 2, 2003

(54) Apparatus for driving 3-electrode plasma display panels that performs scanning using capacitor

(75) Inventor: Joo-Yul Lee, Asan-City (KR)

Correspondence Address: McGuireWoods LLP, Suite 1800, 1750 Tysons Boulevard, McLean, VA, 22102-4215, US

(73) Assignee: Samsung SDI Co., Ltd.

(21) Appl. No.: 10/384,728

(22) Filed: Mar. 11, 2003

(30) Foreign Application Priority Data
Mar. 28, 2002 (KR) 2002-17102

(51) Int. Cl. G09G 3/28

(52) U.S. Cl. 345/60

(57) ABSTRACT

The Y-driver of a 3-electrode plasma display panel driving apparatus includes a switching output circuit and a capacitor. In the switching output circuit, upper and lower transistors are disposed in such a way that the common output line of an upper transistor and a lower transistor is connected to a corresponding Y electrode line. The capacitor is connected between the common power line of all of the upper transistors in the switching output circuit and the common power line of all of the lower transistors in the switching output circuit. A voltage due to charging of the capacitor is applied to the common power line of all of the upper transistors in the switching output circuit.

### BACKGROUND OF THE INVENTION

1. Field of the Invention

The present invention relates to a driving apparatus for 3-electrode plasma display panels, and more particularly, to a driving apparatus for a 3-electrode plasma display panel having a 3-electrode surface-discharge structure, the structure in which X electrode line and Y electrode line are alternately disposed parallel to one another so as to create XY electrode line pairs, address electrode lines are disposed so as to intersect the XY electrode line pairs, and display cells are defined at the intersections.

2. Background Description

FIG. 1 shows the structure of a general 3-electrode surface-discharge type plasma display panel 1, while FIG. 2 shows a display cell on the panel of FIG. 1. Referring to FIGS. 1 and 2, address electrode lines A_{R1} through A_{Rm} (represented by A_{Rm}), A_{G1} through A_{Gm} (represented by A_{Gm}), and A_{B1} through A_{Bm} (represented by A_{Bm}), front dielectric layer 11 and rear dielectric layer 15, Y electrode lines Y₁ through and Yₙ, X electrode lines X₁ through and Xₙ, a fluorescent layer 16, barrier ribs 17, and a magnesium monoxide (MgO) layer 12 as a protective membrane are provided between front glass substrate 10 and rear glass substrate 13 of the general surface-discharge type plasma display panel 1.

The address electrode lines A_{R1}, A_{G1} through A_{Gm}, and A_{Bm} are disposed on the front surface of the rear glass substrate 13 in a predetermined pattern, and entirely coated with the rear dielectric layer 15. The barrier ribs 17 are formed parallel to the address electrode lines A_{R1}, A_{G1} through A_{Gm}, and A_{Bm} on the front surface of the rear dielectric layer 15. The barrier ribs 17 define a discharge area on each display cell and prevent optical cross talk between display cells. The fluorescent layer 16 is formed between the barrier ribs 17.

The X electrode lines X₁ through Xₙ and the Y electrode lines Y₁, through Yₙ are formed on the rear surface of the front glass substrate 10 in a predetermined pattern so that they intersect the address electrode lines A_{R1}, A_{G1} through A_{Gm}, and A_{Bm} at right angles. Each intersection corresponds to a display cell. To form each of the X electrode lines X₁ through Xₙ, a transparent conductive electrode line Xₙₐ of FIG. 2, such as an indium tin oxide (ITO), is combined with a metallic electrode line X_{nb} of FIG. 2 to increase conductivity. Likewise, to form each of the Y electrode lines Y₁ through Yₙ, a transparent conductive electrode line Yₙₐ of FIG. 2, such as an indium tin oxide (ITO), is combined with a metallic electrode line Y_{nb} of FIG. 2 to increase conductivity. The X electrode lines X₁ through and Xₙ and the Y electrode lines Y₁ through and Yₙ are entirely coated with the front dielectric layer 11. The magnesium monoxide (MgO) layer 12 for protecting the panel 1 from a strong electric field is formed on the entire rear surface of the front dielectric layer 11. Plasma forming gas fills a discharge space 14.

FIG. 3 shows a conventional address-display separation driving method of the Y electrode lines of the plasma display panel of FIG. 1. Referring to FIG. 3, a unit frame is divided into 8 sub-fields SF1 through SF8 in order to achieve time-division gray level display. Each of the sub-fields SF1 through SF8 is respectively divided into an address period A1 through A8 and a display sustain period S1 through S8.

During each of the address periods A1 through A8, while a display data signal is applied to the address electrode lines A_{R1}, A_{G1} through A_{Gm}, and A_{Bm} of FIG. 1, appropriate scanning pulses are sequentially applied to the Y electrode lines Y₁ through Yₙ. During the application of the scanning pulses, if a high-level display data signal is applied to an address electrode line, wall charges are formed on a discharge cell corresponding to the address electrode line, but the other discharge cells do not gain wall charges.

In each of the display sustain periods S1 through S8, a display discharge pulse is applied to all of the X electrode lines, X₁ through Xₙ, and all of the Y electrode lines, Y₁ through Yₙ, in such a way that the display discharge pulse alternates between them. As a consequence, a display discharge occurs on discharge cells having wall charges formed in each of the address periods A1 through A8. As a result, the luminance of a plasma display panel is proportional to the length of the display sustain periods S1 through S8 for a unit frame. In the plasma display panel of FIG. 3, the length of the display sustaining periods S1 through S8 for a unit frame is 255T (T denotes a unit of time). Hence, a unit frame can express 256 gray levels including a zero gray level, where no display discharge occurs.

A time 1T, corresponding to 2⁰, is set for the display sustain period S1 of the first sub-field SF1. A time 2T, corresponding to 2¹, is set for the display sustain period S1 of the second sub-field SF2. A time 4T, corresponding to 2², is set for the display sustain period S3 of the third sub-field SF3. A time 8T, corresponding to 2³, is set for the display sustain period S4 of the fourth sub-field SF4. A time 16T, corresponding to 2⁴, is set for the display sustain period S5 of the fifth sub-field SF5. A time 32T, corresponding to 2⁵, is set for the display sustain period S6 of the sixth sub-field SF6. A time 64T, corresponding to 2⁶, is set for the display sustain period S7 of the seventh sub-field SF7. A time 128T, corresponding to 2⁷, is set for the display sustain period S8 of the eighth sub-field SF8.

Accordingly, it can be seen from FIG. 3 that, when sub-fields to be displayed are appropriately selected from the 8 sub-fields, any of the selected sub-fields can display 256 gray levels including a zero gray scale, in which display discharge does not occur.

In the above-described address-display separation driving method, since the subfields SF1 through SF8 are temporally separated in a unit frame, the address period and the display sustain period are temporally separated in each of the subfields SF1 through SF8. To be more specific, in an address period, each pair of X and Y electrodes is addressed, and waits for the next operation until the other pairs of X and Y electrodes are all addressed. Consequently, the time for the address period in each subfield is lengthened, while the display sustain period is relatively shortened. This lowers the luminance of light emitted from a plasma display panel. In order to solve this problem, an address-while-display driving method as shown in FIG. 4 has been developed.

FIG. 4 shows a conventional address-while-display driving method applied to the Y electrode lines of the plasma display panel of FIG. 1. Referring to FIG. 4, a unit frame is divided into 8 subfields SF₁ through SF₈ in order to achieve time-division gray-scale display. The subfields overlap one another with respect to the Y electrode lines Y₁ through Yₙ and constitute a unit frame. Hence, all of the subfields SF₁ through SF₈ exist at every time point and an addressing time slot is set between display discharge pulses in order to perform each addressing.

A reset step, an address step, and a display sustaining step are performed on each of the subfields, and the time allocated to each of the subfields is determined based on a display discharging time corresponding to a gray scale. If 8-bit image data display 256 gray scales per unit frame and the unit frame (generally, 1/60 sec) is divided into 255 unit periods, the first subfield SF₁ driven based on the least significant bit (LSB) image data has one (2⁰) unit period, the second subfield SF₂ has 2 (2¹) unit periods, the third subfield SF₃ has 4 (2²) unit periods, the fourth subfield SF₄ has 8 (2³) unit periods, the fifth subfield SF₅ has 16 (2⁴) unit periods, the sixth subfield SF₆ has 32 (2⁵) unit periods, the seventh subfield SF₇ has 64 (2⁶) unit periods, and the eighth subfield SF₈, driven based on the most significant bit (MSB) of the image data, has 128 (2⁷) unit periods. That is, since the sum of the unit periods allocated to the subfields is 255 unit periods, 255 gray scales can be displayed. If no discharge on any subfield is included, 256 gray scales can be displayed.

FIG. 5 shows a general driving apparatus for the plasma display panel of FIG. 1. Referring to FIG. 5, the general driving apparatus for the plasma display panel 1 of FIG. 1 includes an image processor 66, a logic controller 62, an address driver 63, an X-driver 64, and a Y-driver 65. The image processor 66 converts an external analog image signal into a digital signal and generates an internal image signal, for example, 8-bit red (R) image data, 8-bit green (G) image data, 8-bit blue (B) image data, a clock signal, and vertical and horizontal synchronous signals. The logic controller 62 generates driving control signals S_{A}, S_{Y}, and S_{X} according to the internal image signal received from the image processor 66. The address driver 63 processes the address signal S_{A} out of the driving control signals S_{A}, S_{Y}, and S_{X} to obtain a display data signal, and applies the display data signal to address electrode lines. The X-driver 64 processes the X driving control signal S_{X} out of the driving control signals S_{A}, S_{Y}, and S_{X} and applies the resultant signal to X electrode lines. The Y-driver 65 processes the Y driving control signal S_{Y} out of the driving control signals S_{A}, S_{Y}, and S_{X} and applies the resultant signal to Y electrode lines.

FIG. 6 shows driving signals applied to a unit subfield on the panel of FIG. 1 by the address-display separation driving method of FIG. 3. Referring to FIG. 6, reference character S_{AR1 . . . ABm} denotes a driving signal applied to the address electrode lines A_{R1} through A_{Rm}, A_{G1} through A_{Gm}, and A_{B1} through A_{Bm} of FIG. 1. Reference character S_{X1 . . . Xn} denotes a driving signal applied to the X electrode lines X₁ through Xₙ of FIG. 1, and reference characters S_{Y1} through and S_{Yn} denote a driving signal applied to the Y electrode lines Y₁ through Yₙ of FIG. 1, respectively. FIG. 7 shows wall charges distributed on a display cell at the point in time immediately after a gradual rising voltage is applied to the Y electrode lines Y₁ through Yₙ during a reset period PR of FIG. 6. FIG. 8 shows wall charges distributed on a display cell when the reset period PR of FIG. 6 terminates. Referring to FIG. 6, during the reset period PR of a unit subfield SF, first, the driving voltage S_{X1 . . . Xn} continuously increases from a ground voltage V_{G} to a second voltage V_{S}, for example, 155 V. At this time, the ground voltage V_{G} is applied to the Y electrode lines Y₁, through Yₙ and the address electrode lines A_{R1}, A_{G1} through A_{Gm}, and A_{Bm}. Accordingly, while a weak discharge occurs between the X electrode lines X₁ through Xₙ and the Y electrode lines Y₁ through Yₙ and between the X electrode lines X₁ through Xₙ and the address electrode lines A_{R1} to A_{Bm}, negative wall charges are formed around the X electrode lines X₁ through Xₙ.

Next, the driving voltages S_{Y1} through S_{Yn} continuously increase from the second voltage Vₛ, for example, 155 V, to the highest voltage (V_{SET}+V_{S}), for example, 355 V. The voltage (V_{SET}+V_{S}) is obtained by adding a third voltage V_{SET} to the second voltage V_{S}. While the voltages S_{Y1} through S_{Yn} increase from the second voltage to the highest voltage, the ground voltage V_{G} is applied to the X electrode lines X₁ through Xₙ and the address electrode lines A_{R1} to A_{Bm}. Accordingly, a weak discharge occurs between the X electrode lines and the Y electrode lines, and a weaker discharge occurs between the Y electrode lines and the address electrode lines. The discharge between the X electrode lines and the Y electrode lines is stronger than the discharge between the Y electrode lines and the address electrode lines, because negative wall charges have been formed around the X electrode lines. Consequently, many negative wall charges are formed around the Y electrode lines, positive wall charges are formed around the X electrode lines, and a few positive wall charges are formed around the address electrode lines, as shown in FIG. 7.

After the voltage increases from V_{S} to (V_{SET}+V_{S}), while the driving voltage S_{X1 . . . Xn} is maintained at the second voltage V_{S}, the driving voltages S_{Y1}, through S_{Yn} continuously decreases from the second voltage V_{S} to the ground voltage V_{G}. At this time, the ground voltage V_{G} is applied to the address electrode lines A_{R1}, A_{G1} through A_{Gm}, and A_{Bm}. Accordingly, due to a weak discharge between the X electrode lines and the Y electrode lines, some of the negative wall charges around the Y electrode lines move toward the X electrode lines, as shown in FIG. 8. Also, due to the ground voltage V_{G} being applied to the address electrode lines, the number of positive wall charges around the address electrode lines slightly increases.

Accordingly, during the subsequent address period PA, smooth addressing can be performed as a display data signal is applied to the address electrode lines, and the Y electrode lines biased to a fourth voltage V_{SCAN}, which is lower than the second voltage V_{S}, are sequentially subject to a scanning signal with the ground voltage V_{G}. If a display cell is selected, a display data signal with positive address voltage V_{A} is applied to the address electrode lines. Otherwise, a display data signal with the ground voltage V_{G} is applied to the address electrode lines. Accordingly, when a display data signal with the positive address voltage V_{A} is applied while a scanning pulse with the ground voltage V_{G} is applied, wall charges are formed on a corresponding display cell due to address discharge, but no wall charges are formed on the other display cells. At this time, in order to achieve more accurate and efficient address discharge, the second voltage V_{S} is applied to the X electrode lines.

Subsequently, during the display sustaining period PS, a display sustaining pulse with the second voltage V_{S} is applied to each of the X electrode lines and each of the Y electrode lines in such a way that the display sustaining pulse alternates between them. Thus, a discharge for sustaining the display occurs on display cells having wall charges formed during the address period PA.

FIG. 9 shows a structure of a conventional Y-driver of a driving apparatus for applying the driving signals of FIG. 6. Referring to FIGS. 6 and 9, the conventional Y-driver includes a reset/sustaining circuit RSC, a scan driving circuit AC, and a switching output circuit SIC. The reset/sustaining circuit RSC generates driving signals to be applied to the Y electrode lines during the reset period PR and the display sustaining period PS. The scan driving circuit AC generates driving signals to be applied to the Y electrode lines during the addressing period PA. In the switching output circuit SIC, upper transistors YU1 through YUn and lower transistors YL1 through YLn are disposed to create upper transistor/lower transistor pairs, and the common output lines of the upper transistor/lower transistor pairs are connected to the Y electrode lines Y₁ through Yₙ of the 3-electrode plasma display panel 1. The operation of the Y-driver of FIG. 9 will now be described with reference to FIGS. 6 and 9.

During the reset period PR and the display sustaining period PS, the driving signals O_{RS} from the reset/sustaining circuit RSC are applied to the Y electrode lines of the 3-electrode plasma display panel 1 via a point A in the scan driving circuit AC and the lower transistors YL1 through YLn in the switching output circuit SIC. At this time, all large power transistors S_{SC1}, S_{SC2}, S_{SP}, and S_{SCL} in the scan driving circuit AC are turned off. The driving signals O_{RS} from the reset/sustaining circuit RSC are applied to the Y electrode lines of the 3-electrode plasma display panel 1 via the point A and the third large power transistor S_{SP} in the scan driving circuit AC and the upper transistors YU1 through YUn in the switching output circuit SIC. At this time, the large power transistors S_{SC1}, S_{SC2}, and S_{SCL} excluding the third large power transistor S_{SP} in the scan driving circuit AC are turned off.

During the address period PA, the large power transistors S_{SC1}, S_{SC2}, and S_{SCL} excluding the third large power transistor S_{SP} in the scan driving circuit AC are turned on. A scan bias voltage V_{SCAN} is applied via the first large power transistor S_{SC1} and second large power transistors S_{SC2} to the upper transistors YU1 through YUn of the switching output circuit SIC. The ground voltage V_{G} (FIG. 6) is applied to the lower transistors YL1 through YLn of the switching output circuit SIC via the fourth large power transistor S_{SCL}. In this case, the lower transistor connected to a Y electrode line to be scanned is turned on, while the upper transistor connected to the Y electrode line to be scanned is turned off. The lower transistors connected to the other Y electrode lines not to be scanned are turned off, while the upper transistors connected to the Y electrode lines not to be scanned are turned on. The scan ground voltage V_{G} is then applied to the Y electrode line to be scanned, and the scan bias voltage V_{SCAN} is applied to the other Y electrode lines not to be scanned.

During the addressing period PA, when the scan ground voltage V_{G} is applied to the Y electrode line to be scanned, current from the display cells (electrical capacitors) connected to the Y electrode line to be scanned passes through a lower transistor in the switching output circuit SIC and the fourth large power transistor S_{SCL} in the scan driving circuit AC and then flows to a ground terminal.

During the addressing period PA, when a display data signal is applied to the address electrode lines, discharge current from the address electrode lines to which a selection voltage V_{A} has been applied flows to an Y electrode line that is being scanned. At this time, current sequentially passes through the other Y electrode lines not being scanned, the upper transistors of the switching output circuit SIC, and the first and second large power transistors S_{SC1} and S_{SC2} in the scan driving circuit AC and then flows to the terminal of the scan bias voltage V_{SCAN}.

During the addressing period PA, at the point in time when the application of the display data signal to the address electrode lines A_{R1}, A_{G1} through A_{Gm}, and A_{Bm} terminates, current from the terminal of the scan bias voltage V_{SCAN} passes through the first and second large power transistors S_{SC1} and S_{SC2} in the scan driving circuit AC, the upper transistors of the switching output circuit SIC, and the Y electrode lines and then flows to the address electrodes A_{R1}, A_{G1} through A_{Gm}, and A_{Bm}.

During the addressing period PA, at the point in time when the application of the scan ground voltage V_{SCAN} to the one Y electrode line to be scanned terminates, current from the terminal of the scan bias voltage V_{SCAN} passes through the first and second large power transistors S_{SC1} and S_{SC2} in the scan driving circuit AC, the upper transistors of the switching output circuit SIC, and the Y electrode lines and then flows to the display cells (electrical capacitors).

Accordingly, it can be seen that large power transistors for switching must be connected between the common line of the upper transistors in the SIC and the terminal of the scan bias voltage V_{SCAN}. When only one large power transistor S_{SC1} or S_{SC2} is connected, the following two problems are generated.

Firstly, if only the second large power transistor S_{SC2} is connected, the driving signals O_{RS} from the reset/sustaining circuit RSC are applied to the terminal of the scan bias voltage V_{SCAN} via the internal diode of the second large power transistor S_{SC2} during the reset period PR and the display sustaining period PS, such that current flows. As a result, driving during the reset period PR and the display sustaining period PS is unstable, and power consumption increases.

Secondly, if only the first large power transistor S_{SC1} is connected, an unexpected over-shoot pulse from the reset/sustaining circuit RSC can be applied to the upper transistors YU1 through YUn of the switching output circuit SIC through the internal diode of the first large power transistor S_{SC1}. As a result, driving during each of the periods may be unstable. For these reasons, two large power transistors S_{SC1} and S_{SC2} are needed.

If the upper and lower common lines are simply disconnected because of absence of the third large power transistor S_{SP}, the driving signals O_{RS} from the reset/sustaining circuit RSC are applied to all of the Y electrode lines Y₁ through Yₙ through the lower transistors YL1 through YLn of the SIC during the reset period PR and the display sustaining period PS, and also applied to the first large power transistor S_{SC1} through the internal diodes of the upper transistors and the second large power transistor S_{SC2} in the scan driving circuit AC. As a result, the performance of the first large power transistor S_{SC1} can be degraded, and the durability shortened. However, if the third large power transistor S_{SP} exists, a predetermined voltage drops to the third large power transistor S_{SP}. Thus, a voltage applied to the first large power transistor S_{SC1} can be lowered.

As described above, a conventional apparatus for driving a 3-electrode plasma display panel has a deficiency in that the scan driving circuit AC of a Y driver requires four expensive large power transistors S_{SC1}, S_{SC2}, S_{SP}, and S_{SCL}.

### SUMMARY OF THE INVENTION

To solve the above and other problems, it is an object of the present invention to provide a driving apparatus for a 3-electrode plasma display panel, by which the number of costly large power transistors required by the scan driving circuit of a Y driver is minimized.

To achieve the above and other objects, a 3-electrode plasma display panel driving apparatus of the present invention includes an image processor for converting an external analog image signal into a digital signal to obtain an internal image signal, a controller for generating driving control signals according to the internal image signal of the image processor, an address driver for processing an address signal from the controller to obtain a display data signal and applying the display data signal to address electrode lines, an X-driver for processing an X driving control signal from the controller and applying the processed X driving control signal to X electrode lines, and a Y-driver for processing a Y driving control signal from the controller and applying the processed Y driving control signal to Y electrode lines.

The Y-driver includes a switching output circuit and a capacitor. In the switching output circuit, upper transistor and lower transistor are disposed in such a way that the common output line of an upper transistor and a lower transistor is connected to a corresponding Y electrode line. The capacitor is connected between the common power line of all the upper transistors in the switching output circuit and the common power line of all the lower transistors in the switching output circuit. Here, a voltage due to charging of the capacitor is applied to the common power line of all the upper transistors in the switching output circuit.

According to the 3-electrode plasma display panel driving apparatus, since a constant voltage can be maintained in the capacitor, two large power transistors as required in a conventional Y-driver do not need to be connected between the common power line of the upper transistors of the switching output circuit and a power terminal.

### BRIEF DESCRIPTION OF THE DRAWINGS

The above and other objects and advantages of the present invention will become more apparent by describing in detail preferred embodiments thereof with reference to the attached drawings.

FIG. 1 is an internal perspective view of the structure of a general 3-electrode surface-discharge type plasma display panel.

FIG. 2 is a cross-section of a display cell of the panel of FIG. 1.

FIG. 3 is a timing diagram showing a conventional address-display separation driving method of the Y electrode lines of the plasma display panel of FIG. 1.

FIG. 4 is a timing diagram showing a conventional address-while-display driving method of the Y electrode lines of the plasma display panel of FIG. 1.

FIG. 5 is a block diagram of a general driving apparatus for the plasma display panel of FIG. 1.

FIG. 6 is a timing diagram showing driving signals applied to a unit subfield on the panel of FIG. 1 by the address-display separation driving method of FIG. 3.

FIG. 7 is a cross-sectional view showing wall charges distributed on a display cell at an instant of the point in time immediately after a gradual rising voltage is applied to the Y electrode lines during the reset period of FIG. 6.

FIG. 8 is a cross-sectional view showing wall charges distributed on a display cell at the point in time when the reset period of FIG. 6 is terminated.

FIG. 9 is a circuit diagram showing a conventional scan driving circuit and a switching output circuit that are included in a Y driver of a driving apparatus for applying the driving signals of FIG. 6.

FIG. 10 is a circuit diagram showing a scan driving circuit according to an embodiment of the present invention and a switching output circuit that are included in the Y-driver of a driving apparatus for applying the driving signals of FIG. 6.

FIG. 11 is a circuit diagram of the reset/sustaining circuit of FIG. 10.

FIG. 12 is a circuit diagram showing a scan driving circuit according to another embodiment of the present invention and a switching output circuit that are included in the Y driver of a driving apparatus for applying the driving signals of FIG. 6.

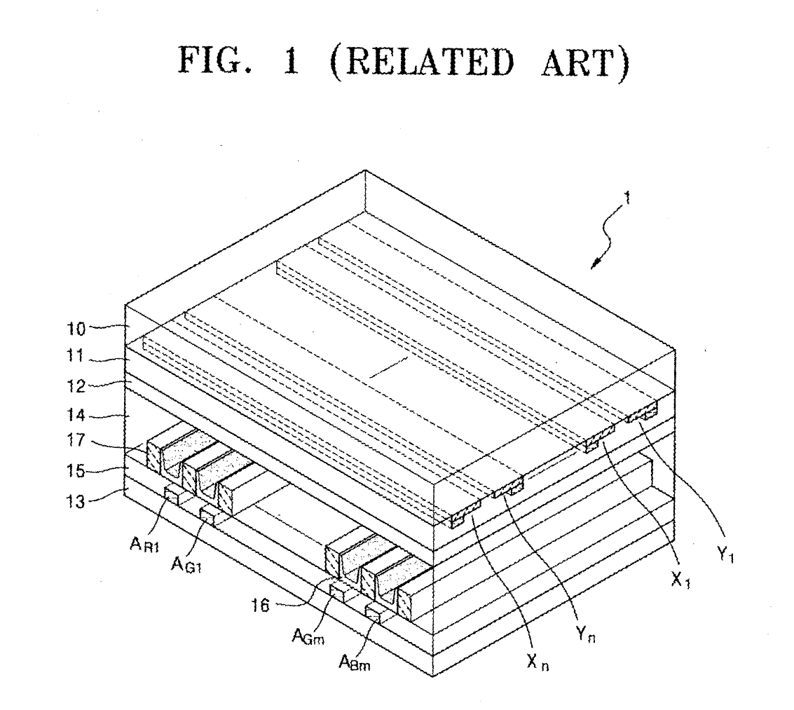

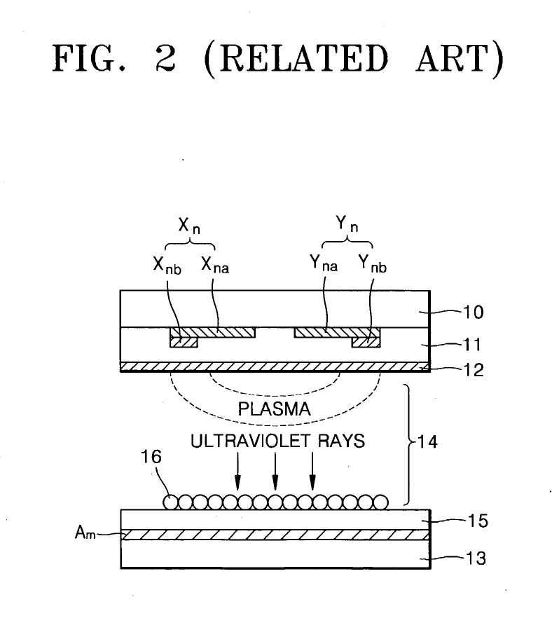

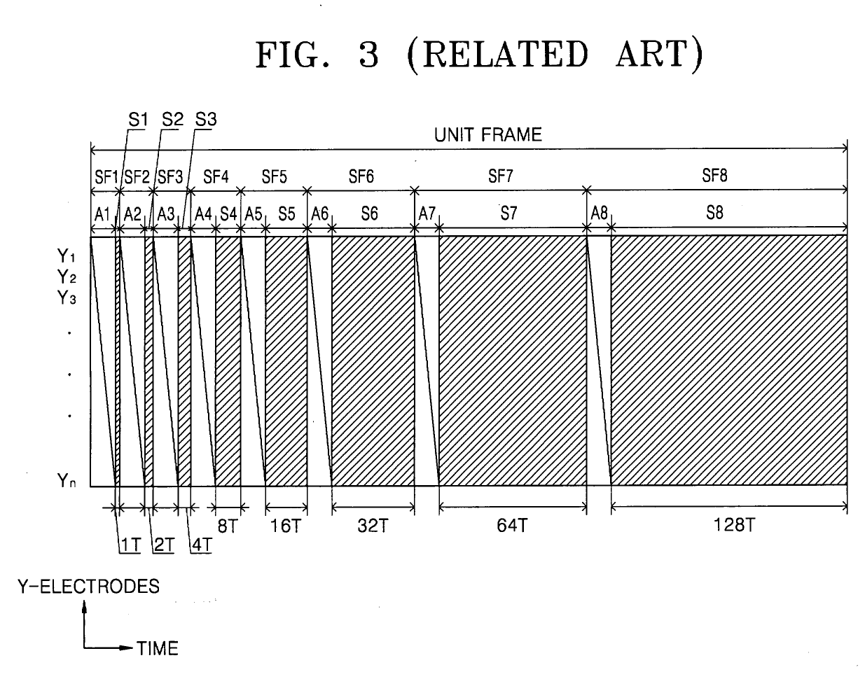

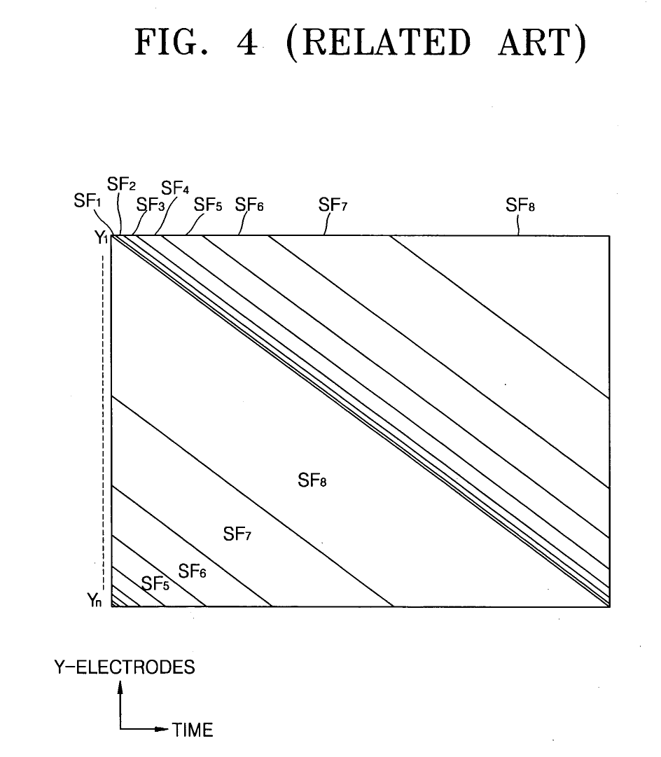

### DETAILED DESCRIPTION OF THE INVENTION

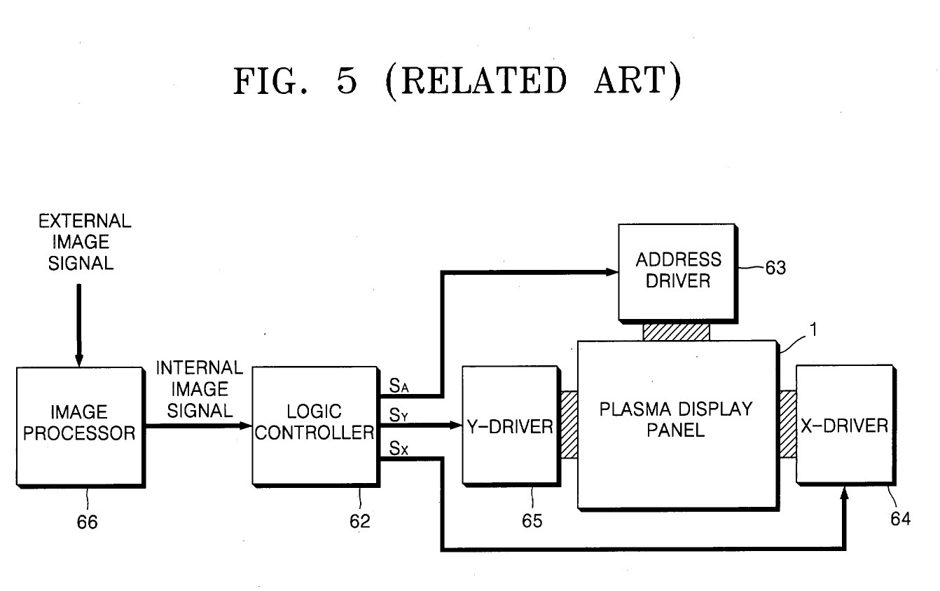

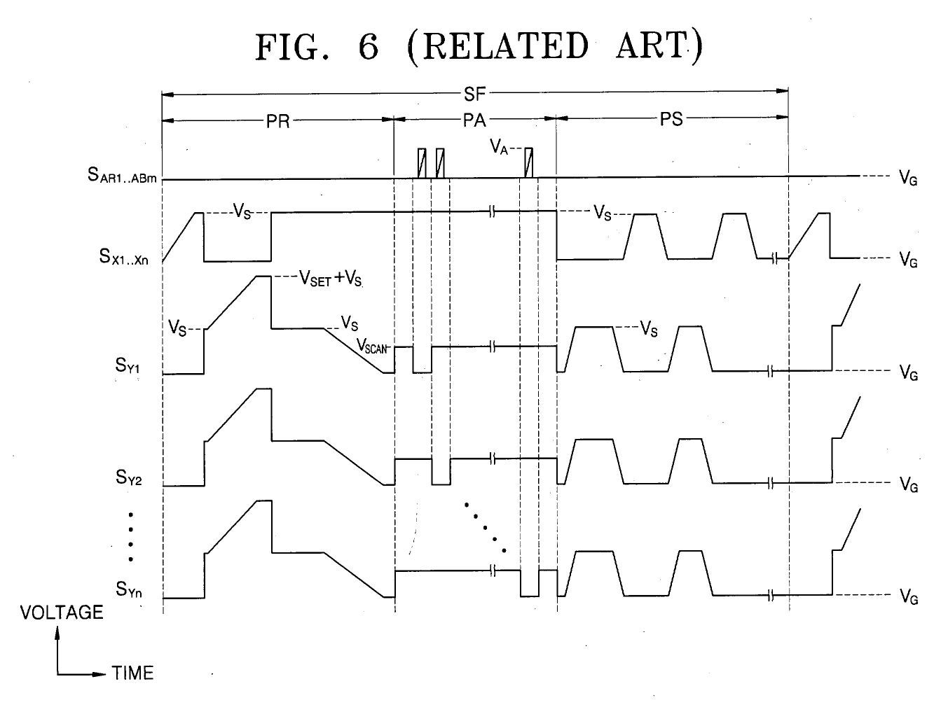

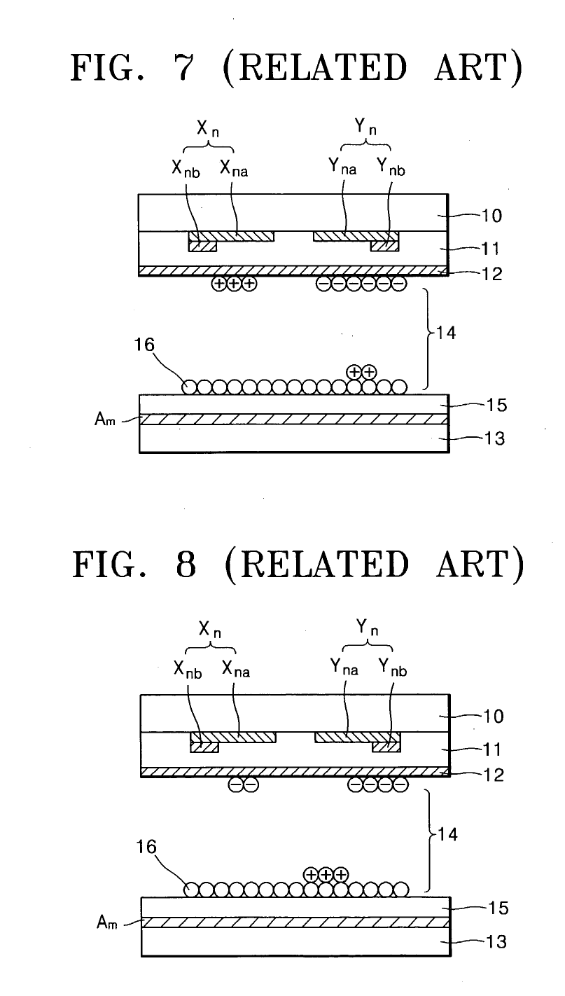

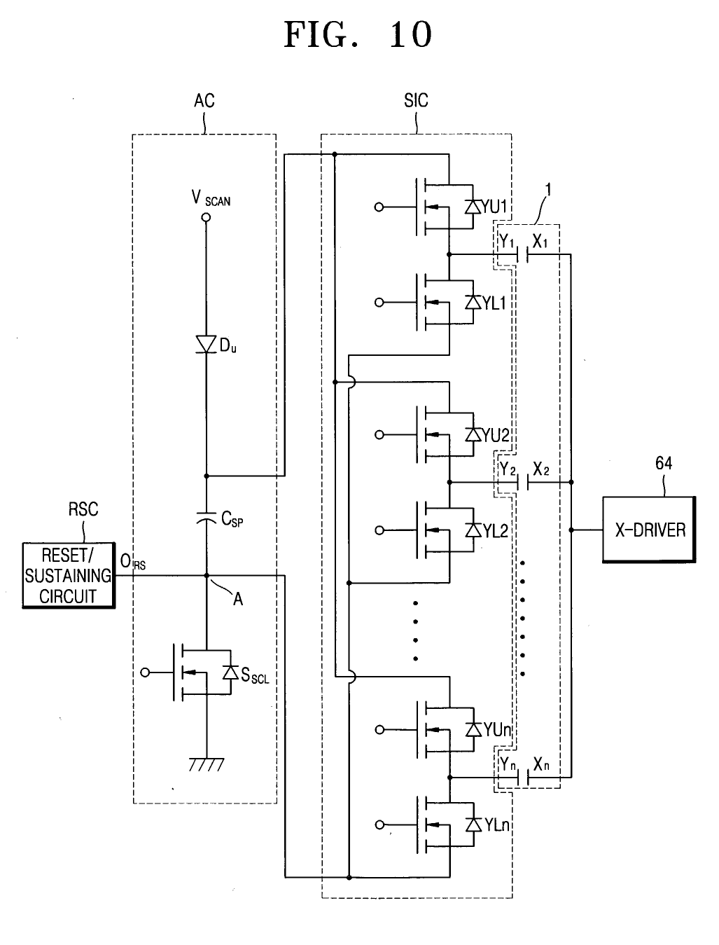

FIG. 10 shows a scan driving circuit (AC) according to an embodiment of the present invention and a switching output circuit (SIC) that are included in the Y-driver 65 of FIG. 5 in the driving apparatus for applying the driving signals of FIG. 6. Referring to FIGS. 5 and 10, a 3-electrode plasma panel driving apparatus according to the present invention includes an image processor 66, a logic controller 62, an address driver 63, an X-driver 64, and a Y-driver 65.

The Y-driver 65 includes a reset/sustaining circuit RSC, a scan driving circuit AC, and a switching output circuit SIC. The reset/sustaining circuit RSC generates driving signals to be applied to the Y electrode lines Y₁ through Yₙ during the reset period PR and the display sustaining period PS. The scan driving circuit AC generates driving signals to be applied to the Y electrode lines Y₁ through Yₙ during the addressing period PA. In the switching output circuit SIC, upper transistors YU1 through and YUn and lower transistors YL1 through YLn are disposed such as to obtain upper transistor/lower transistor pairs, and the common output lines of the upper transistor/lower transistor pairs are connected to the Y electrode lines Y₁ through Yₙ of the 3-electrode plasma display panel 1.

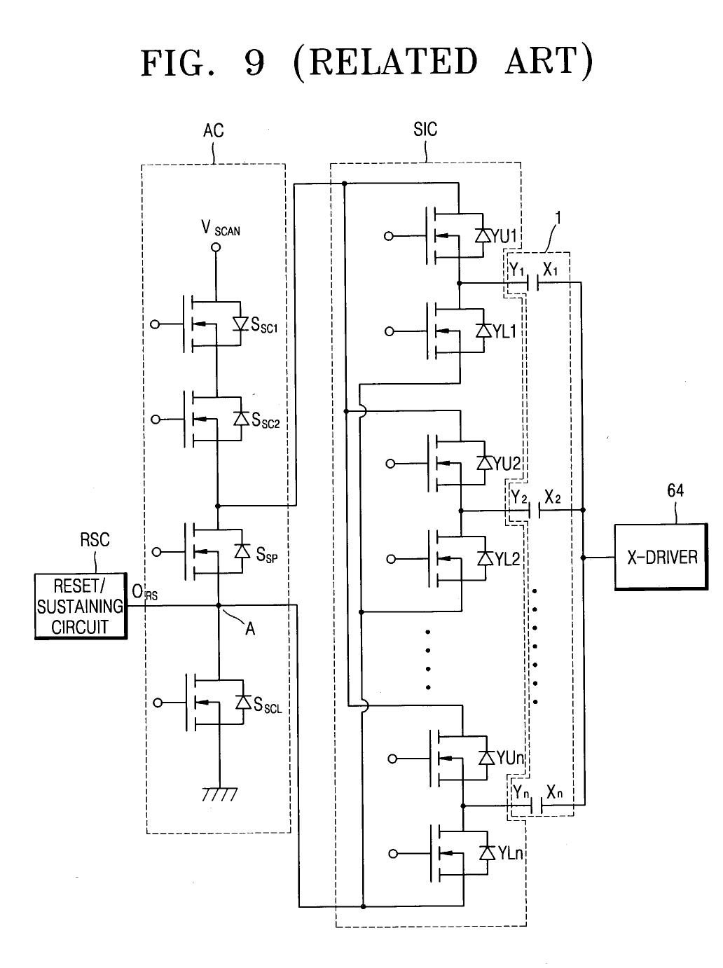

A capacitor C_{SP} included in the scan driving circuit AC is connected between the common power line of all upper transistors YU1 through YUn in the SIC and the common power line of all lower transistors YL1 through YLn of the SIC. A voltage obtained by charging the capacitor C_{SP} is applied to the common power line of the upper transistors YU1 through YUn of the SIC. Accordingly, the capacitor C_{SP} can be charged with a constant voltage all the time, such that the two large power transistors S_{SC1} and S_{SC2} of FIG. 9 do not need to be provided between the common power line of the upper transistors YU1 through YUn of the switching output circuit SIC and a power terminal, that is, the port of a scan bias voltage V_{SCAN}. Also, the large power transistor S_{SP} does not need to be connected to the capacitor C_{SP}. The reason for the above fact is as follows.

In the scan driving circuit AC, a diode D_{U} to serve as a one-way current control device is connected to the common power line of all of the upper transistors YU1 through YUn of the switching output circuit SIC and the terminal of the scan bias voltage V_{SCAN}. Hence, the capacitor C_{SP} is charged by the diode D_{U}, and the scan bias voltage V_{SCAN} due to the charging is applied to the common power line of the upper transistors YU1 through YUn of the switching output circuit SIC. A large power transistor S_{SCL} is connected between the common power line of the lower transistors YL1 through YLn of the switching output circuit SIC and a ground line. The operation of the Y-driver of FIG. 10 will now be described with reference to FIGS. 6 and 10.

During the reset period PR and the display sustaining period PS, excluding a scanning time (addressing period PA), the large power transistor S_{SCL} is turned off, such that the driving signals O_{RS} from the reset/sustaining circuit RSC are applied to the common power line of all of the lower transistors YL1 through YLn in the switching output circuit SIC. At this time, all of the lower transistors YL1 through YLn in the switching output circuit SIC are turned on, and all of the upper transistors YU1 through YUn are turned off. Accordingly, the driving signals O_{RS} from the RSC are applied to the Y electrode lines Y₁ through Yₙ via the lower transistors YL1 through YLn in the switching output circuit SIC.

During the addressing period PA, that is, the scanning period, a scan bias voltage V_{SCAN} due to charging of the capacitor C_{SP} is applied to the common power line of the upper transistors YU1 through YUn of the switching output circuit SIC. Since the large power transistor S_{SCL} is turned on, the ground voltage V_{G} of FIG. 6 is applied via the large power transistor S_{SCL} to the lower transistors YL1 through YLn of the switching output circuit SIC. In this case, the lower transistor connected to a Y electrode line to be scanned is turned on, while the upper transistor connected to the Y electrode line to be scanned is turned off. The lower transistors connected to the other Y electrode lines not to be scanned are turned off, while the upper transistors connected to the Y electrode lines not to be scanned are turned on. Hence, the scan ground voltage V_{G} is applied to the one Y electrode line to be scanned, and the scan bias voltage V_{SCAN} is applied to the other Y electrode lines not to be scanned.

During the addressing period PA, the current paths at the point in time when the scan ground voltage V_{G} is applied to the one Y electrode line to be scanned, when a display data signal is applied to the address electrode lines A_{R1}, A_{G1} through A_{Gm}, and A_{Bm}, when the application of the display data signal to the address electrode lines is terminated, and when the application of the scan ground voltage V_{SCAN} to the one Y electrode line to be scanned is terminated, will now be described.

Firstly, at the point in time when the scan ground voltage V_{G} is applied to the one Y electrode line to be scanned, current from the display cells (electrical capacitors) connected to the one Y electrode line to be scanned passes through a lower transistor in the switching output circuit SIC and the large power transistor S_{SCL} in the scan driving circuit AC and then flows to a ground terminal.

Secondly, at the point in time when a display data signal is applied to the address electrode lines A_{R1}, A_{G1} through A_{Gm}, and A_{Bm}, discharge current from the address electrode lines to which a selection voltage V_{A} has been applied flows to an Y electrode line that is being scanned. At this time, current sequentially passes through the other Y electrode lines not scanned, the upper transistors of the switching output circuit SIC, the capacitor C_{SP} in the scan driving circuit AC, and the large power transistor S_{SCL} in the scan driving circuit AC and then flows to the ground terminal.

Thirdly, at the point in time when the application of the display data signal to the address electrode lines terminates, current from the capacitor C_{SP} of the scan driving circuit AC passes through the upper transistors of the switching output circuit SIC and the Y electrode lines and then flows to the address electrodes A_{R1}, A_{G1} through A_{Gm}, and A_{Bm}.

Fourthly, at the point in time when the application of the scan ground voltage V_{G} to the one Y electrode line to be scanned terminates, current from the capacitor C_{SP} of the scan driving circuit AC passes through the upper transistors of the switching output circuit SIC and the Y electrode lines and then flows to the display cells (electrical capacitors).

During the reset period PR, the addressing period PA, and the display sustaining period PS, a constant voltage flows in the capacitor C_{SP}. This prevents unstable driving and does not increase power consumption (refer to the description of the prior art). As a result, the scan driving circuit AC according to the present invention can save 3 costly large power transistors compared to a conventional scan driving circuit (e.g., the scan driving circuit AC of FIG. 9).

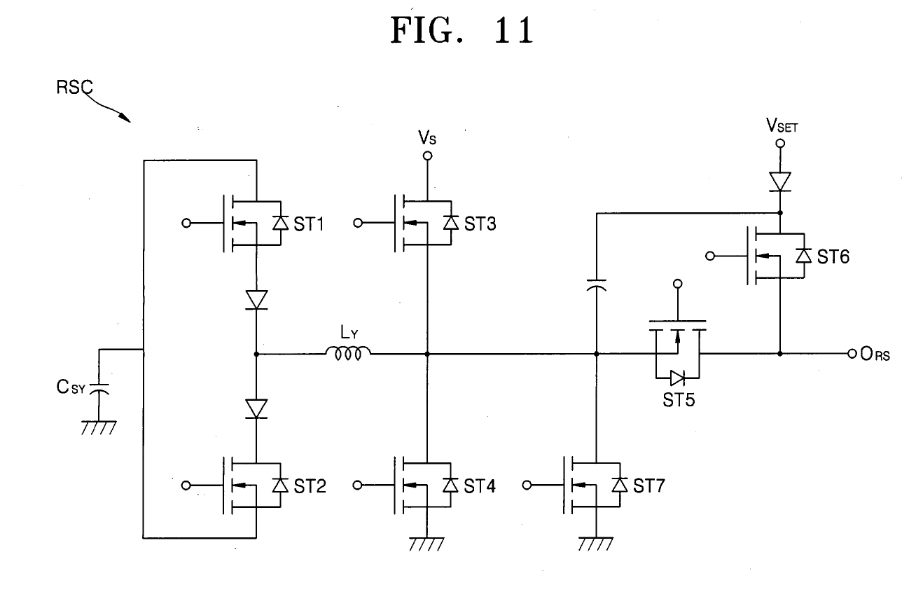

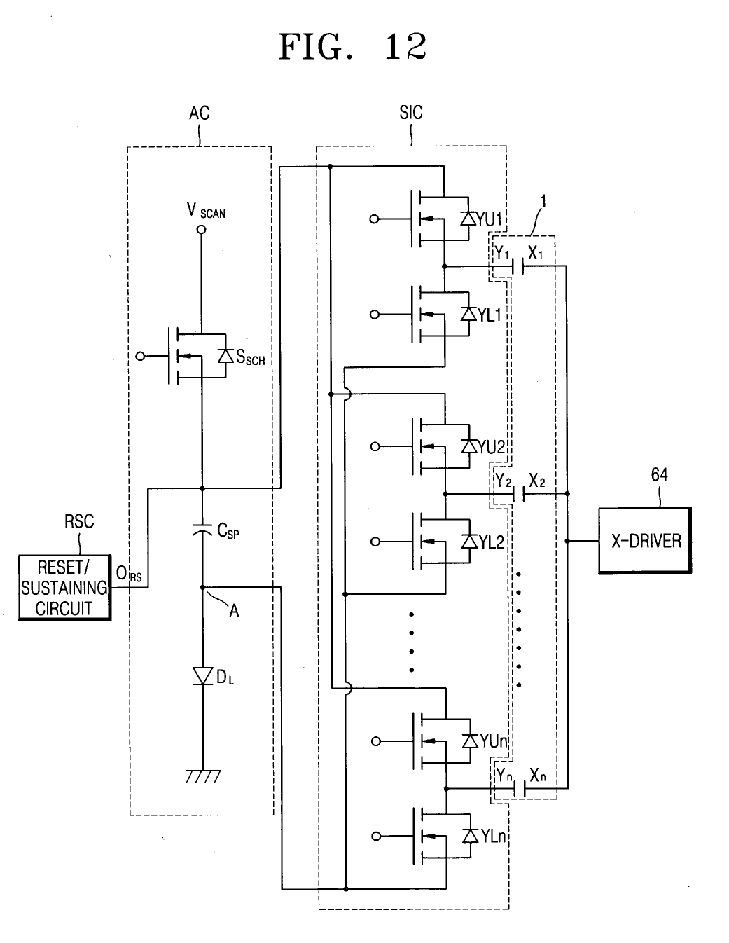

FIG. 11 shows the reset/sustaining circuit RSC of FIG. 10. Referring to FIG. 11, first through sixth transistors ST3 through ST6 generate a driving signal O_{RS} to be applied to the Y electrode lines during the reset period PR. A power reproduction capacitor C_{SY}, first through fifth transistors ST1 through ST5, and a tuning coil L_{Y} generate the driving signal O_{RS} to be applied to the Y electrode lines during the display sustaining period PS. The operation of the reset/sustaining circuit RSC of FIG. 11 will now be described with reference to FIGS. 6 and 11.

During the reset period PR of a unit subfield SF, only the fourth and fifth transistors ST4 and ST5 are turned on while a voltage applied to X electrode lines X₁ through Xₙ continuously increases from the ground voltage V_{G} to a second voltage V_{S}, for example, 155V. Accordingly, the ground voltage V_{G} is applied to the all of the Y electrode lines Y₁ through Yₙ.

Next, only the third transistor ST3 and the sixth transistor ST6 are turned on, and a third voltage V_{SET} is applied to the drain of the sixth transistor ST6. At this time, a continuously rising control voltage is applied to the gate of the sixth transistor ST6, such that the channel resistance value of the sixth transistor ST6 continuously decreases. Also, since the second voltage V_{S} is applied to the source of the third transistor ST3, a voltage that rises from the second voltage V_{S} and a maximum voltage (V_{SET}+V_{S}) is applied to the drain of the sixth transistor ST6 by the action of the capacitor connected between the source of the third transistor ST3 and the drain of the sixth transistor ST6. Accordingly, the voltage that rises from the second voltage V_{S} and the maximum voltage (V_{SET}+V_{S}), for example, 355V, is applied to all of the Y electrode lines Y₁ through Yₙ.

Thereafter, only the third and fifth transistors ST3 and ST5 are turned on, such that the second voltage V_{S} is applied to all of the Y electrode lines Y₁ through Yₙ.

Next, only the fifth and seventh transistors ST5 and ST7 are turned on, and a continuously rising control voltage is applied to the gate of the seventh transistor ST7, such that the channel resistance value of the seventh transistor ST7 continuously decreases. Accordingly, the voltage applied to all of the Y electrode lines Y₁ through Yₙ continuously falls from the second voltage V_{S} to the ground voltage V_{G}.

During the following addressing period PA, all of the transistors ST3 through ST6 of the RSC are turned off, such that the output of the RSC enters into an electrical floating state.

During the following display sustaining period PS, while a unit pulse applied to all of the Y electrode lines Y₁ through Yₙ falls from the second voltage V_{S} to the ground voltage V_{G}, only the second and fifth transistors ST2 and ST5 are turned on. Hence, charges unnecessarily remaining in the display cells (electrical capacitors) are collected in the power reproduction capacitor C_{SY}. The collected charges are applied to all of the Y electrode lines Y₁ through Yₙ while the unit pulse rises from the ground voltage V_{G} to the second voltage V_{S}, so that they are re-cycled.

If the above fact is described step by step, first, only the second and fifth transistors ST2 and ST5 are turned on while a unit pulse applied to all of the Y electrode lines Y₁ through Yₙ rises from the ground voltage V_{G} to the second voltage V_{S}. Hence, charges collected in the power reproduction capacitor C_{SY} are applied to all of the Y electrode lines Y₁ through Yₙ.

Next, only the third and fifth transistors ST3 and ST5 are turned on, such that the second voltage V_{S} is applied to all of the Y electrode lines Y₁ through Yₙ.

Thereafter, only the second and fifth transistors ST2 and ST5 are turned on while a voltage falls from the second voltage V_{S} to the ground voltage V_{G}. Hence, charges unnecessarily remaining in the display cells (electrical capacitors) are collected in the power reproduction capacitor C_{SY}.

In the end, only the fourth and fifth transistors ST4 and ST5 are turned on, such that the ground voltage V_{G} is applied to all of the Y electrode lines Y₁ through Yₙ.

FIG. 12 is a circuit diagram showing a scan driving circuit AC according to another embodiment of the present invention and a switching output circuit SIC that are included in the Y driver 65 of FIG. 5 in the driving apparatus for applying the driving signals of FIG. 6.

A capacitor C_{SP} included in the scan driving circuit AC is connected between the common power line of all upper transistors YU1 through YUn in the switching output circuit SIC and the common power line of all lower transistors YL1 through YLn of the switching output circuit SIC. A voltage obtained by charging the capacitor C_{SP} is applied to the common power line of the upper transistors YU1 through YUn of the switching output circuit SIC. Accordingly, the capacitor C_{SP} can be charged with a constant voltage all the time, so that the two large power transistors S_{SC1} and S_{SC2} of FIG. 9 do not need to be provided between the common power line of the upper transistors YU1 through YUn of the switching output circuit SIC and a power terminal, that is, the port of a scan bias voltage V_{SCAN}. Also, the large power transistor S_{SP} does not need to be connected to the capacitor C_{SP}. The reason for the above fact is as follows.

In the scan driving circuit AC, a large power transistor S_{SCH} is connected to the common power line of all the upper transistors YU1 through YUn of the switching output circuit SIC and the terminal of the scan bias voltage V_{SCAN.} The capacitor C_{SP} is charged through the large power transistor S_{SCH}, and the scan bias voltage V_{SCAN}, due to the charging, is applied to the common power line of the upper transistors YU1 through YUn of the switching output circuit SIC. A diode D_{L} serving as a one-way current control device is applied to the common power line of the lower transistors YL1 through YLn of the switching output circuit SIC and a ground line. The operation of the Y-driver of FIG. 12 will now be described with reference to FIGS. 6 and 12.

During the reset period PR and the display sustaining period PS, excluding a scanning time (addressing period PA), the large power transistor S_{SCH} is turned off. The driving signals O_{RS} from the reset/sustaining circuit RSC are applied to the common power line of all the upper transistors YU1 through YUn in the switching output circuit SIC. At this time, all of the upper transistors YU1 through YUn in the switching output circuit SIC are turned on, and all of the lower transistors YL1 through YLn are turned off. Accordingly, the driving signals O_{RS} from the reset/sustaining circuit RSC are applied to the Y electrode lines Y₁ through Yₙ via the upper transistors YU1 through YUn in the switching output circuit SIC.

During the addressing period PA, that is, the scanning period, a scan bias voltage V_{SCAN} due to charging of the capacitor C_{SP} is applied to the common power line of the upper transistors YU1 through YUn of the SIC. The ground voltage V_{G} of FIG. 6 is also applied via the diode D_{L} to the lower transistors YL1 through YLn of the switching output circuit SIC. In this case, the lower transistor connected to a Y electrode line to be scanned is turned on, while the upper transistor connected to the Y electrode line to be scanned is turned off. The lower transistors connected to the other Y electrode lines not to be scanned are turned off, while the upper transistors connected to the Y electrode lines not to be scanned are turned on. Hence, the scan ground voltage V_{G} is applied to the one Y electrode line to be scanned, and the scan bias voltage V_{SCAN} is applied to the other Y electrode lines not to be scanned.

During the addressing period PA, the current paths at the point in time when the scan ground voltage V_{G} is applied to the one Y electrode line to be scanned, when a display data signal is applied to the address electrode lines A_{R1}, A_{G1} through A_{Gm}, and A_{Bm}, when the application of the display data signal to the address electrode lines A_{R1}, A_{G1} through A_{Gm}, and A_{Bm} is terminated, and when the application of the scan ground voltage V_{SCAN} to the one Y electrode line to be scanned terminates, will now be described.

Firstly, when the scan ground voltage V_{G} is applied to the one Y electrode line to be scanned, current from the display cells (electrical capacitors) connected to the one Y electrode line to be scanned passes through a lower transistor in the switching output circuit SIC and the diode D_{L} in the scan driving circuit AC and then flows to a ground terminal.

Secondly, when a display data signal is applied to the address electrode lines A_{R1,} A_{G1} through A_{Gm}, and A_{Bm}, discharge current from the address electrode lines to which a selection voltage V_{A} has been applied flows to a Y electrode line that is being scanned. At this time, current sequentially passes through the other Y electrode lines not scanned, the upper transistors of the switching output circuit SIC, the capacitor C_{SP} in the scan driving circuit AC, and the diode D_{L} in the scan driving circuit AC and then flows to the ground terminal.

Thirdly, when the application of the display data signal to the address electrode lines A_{R1}, A_{G1} through A_{Gm}, and A_{Bm} terminates, current from the capacitor C_{SP} of the AC passes through the upper transistors of the SIC and the Y electrode lines and then flows to the address electrodes A_{R1}, A_{G1} through A_{Gm}, and A_{Bm}.

Fourthly, when the application of the scan ground voltage V_{G} to the one Y electrode line to be scanned terminates, current from the capacitor C_{SP} of the scan driving circuit AC passes through the upper transistors of the SIC and the Y electrode lines and then flows to the display cells (electrical capacitors).

During the reset period PR, the addressing period PA, and the display sustaining period PS, a constant voltage flows in the capacitor C_{SP}. As a result, driving is prevented from becoming unstable, and an increase in power consumption is counteracted. As a result, the scan driving circuit AC according to the present invention can save the cost of three large power transistors compared to a conventional scan driving circuit (e.g., the scan driving circuit AC of FIG. 9).

As described above, in a 3-electrode plasma display panel driving apparatus according to the present invention, since a constant voltage is maintained in the capacitor CSP of the scan driving circuit AC of the Y-driver, two large power transistors as required in a conventional scan driving circuit AC do not need to be connected between the common power line of the upper transistors YU1 through YUn of the SIC and the power terminal of the scan bias voltage V_{SCAN}. Further, not even one large power transistor needs to be connected to the capacitor C_{SP}.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A plasma display panel driving apparatus comprising:
a switching output circuit having upper transistors and lower transistors disposed in such a way that the common output line of an upper transistor and a lower transistor is connected to a corresponding Y electrode line;
a capacitor connected between the common power line of all of the upper transistors in the switching output circuit and the common power line of all of the lower transistors in the switching output circuit; and
a voltage terminal supplying a scan bias voltage to the capacitor.

2. The plasma display panel driving apparatus of claim 1, further comprising:
a one-way current control device connected between the common power line of all of the upper transistors of the switching output circuit and the voltage terminal of a scan bias voltage.

3. The plasma display panel driving apparatus of claim 2, wherein the capacitor is charged through the one-way current control device.

4. The plasma display panel driving apparatus of claim 1, wherein the scan bias voltage due to the charging is applied to the common power line of the upper transistors of the switching output circuit.

5. The plasma display panel driving apparatus of claim 2, wherein the one-way current control device is a diode.

6. The plasma display panel driving apparatus of claim 2, wherein a switching transistor is connected between the common power line of all of the lower transistors of the switching output circuit and a ground line, and turned off during periods other than a scanning period, such that additional driving signals are applied to the common power line of all of the lower transistors of the switching output circuit.

7. The plasma display panel driving apparatus of claim 1, wherein a switching transistor is connected between the common power line of all of the upper transistors of the switching output circuit and the terminal of the scan bias voltage, the capacitor is charged while the switching transistor is turned on, the scan bias voltage due to the charging is applied to the common power line of all of the upper transistors of the switching output circuit.

8. The plasma display panel driving apparatus of claim 7, wherein the switching transistor is turned off during periods other than a scanning period, such that additionally required driving signals are applied to the common power line of all of the upper transistors of the switching output circuit.

9. The plasma display panel driving apparatus of claim 7, wherein a one-way current control device is connected between the common power line of all of the lower transistors of the switching output circuit and a ground line.

10. A plasma display panel driving apparatus, comprising:
a controller for generating driving control signals according to an internal image signal;
an address driver for processing an address signal from the controller to obtain a display data signal and applying the display data signal to address electrode lines;
a Y-driver for processing a Y driving control signal from the controller and applying the processed Y driving control signal to Y electrode lines, wherein the Y-driver comprises:
a switching output circuit having upper transistors and lower transistors disposed so that the common output line of an upper transistor and a lower transistor is connected to a corresponding Y electrode line;
a capacitor connected between the common power line of all of the upper transistors in the switching output circuit and the common power line of all of the lower transistors in the switching output circuit; and
a voltage terminal supplying a scan bias voltage to the capacitor.

11. The plasma display panel driving apparatus of claim 10, further comprising:
an X-driver for processing an X driving control signal from the controller and applying the processed X driving control signal to X electrode lines; and
an image processor for converting an external analog image signal into a digital signal to obtain the internal image signal.

12. The plasma display panel driving apparatus of claim 10, wherein the Y-driver further comprises a one-way current control device connected between the common power line of all the lower transistors of the switching output circuit and a ground line.

13. The plasma display panel driving apparatus of claim 10, wherein the Y-driver further comprises a switching transistor connected between the scan bias voltage terminal and the capacitor, the capacitor is charged while the switching transistor is turned on, the scan bias voltage due to the charging applied to the common power line of all the upper transistors of the switching output circuit.

14. The plasma display panel driving apparatus of claim 13, wherein the Y-driver further comprises a reset/sustaining circuit connected to all of the upper transistors in the switching output circuit and connected to a contact between the switching transistor and the capacitor, the reset/sustaining circuit generating driving signals applied to the Y-electrode lines.

15. The plasma display panel driving apparatus of claim 14, wherein the switching transistor is turned off during periods other than a scanning period when driving signals from the reset/sustaining circuit are applied to the common power line of all the upper transistors of the switch output circuit.

16. The plasma display panel driving apparatus of claim 10, wherein the Y-driver further comprises a one-way current control device connected between the common power line of all of the upper transistors of the switching output circuit and the voltage terminal of a scan bias voltage, the capacitor is charged through the one-way current control device, the scan bias voltage due to the charging is applied to the common power line of the upper transistors of the switching output circuit.

17. The plasma display panel driving apparatus of claim 10, wherein the Y-driver further comprises a switching transistor connected between the common power line of all of the lower transistors of the switching output circuit and a ground line.

18. The plasma display panel driving apparatus of claim 17, wherein the Y-driver further comprises a reset/sustaining circuit connected to all of the lower transistors in the switching output circuit and connected to a contact between the switching transistor and the capacitor, the reset/sustaining circuit generating driving signals applied to the Y-electrode lines.

19. The plasma display panel driving apparatus of claim 18, wherein the switching transistor is turned off during periods other than a scanning period when driving signals from the reset/sustaining circuit are applied to the common power line of all the lower transistors of the switch output circuit.
